(19) United States
(12) Patent Application Publication
(10) Pub. No.: US 2026/0292631 A1
(43) Pub. Date: Sep. 24, 2026

(54) Methods for IAB-node mobility with anchor CU

(71) Applicant: TELEFONAKTIEBOLAGET LM ERICSSON (PUBL), Stockholm (SE)

(72) Inventors: Filip Barac, HUDDINGE (SE); Ritesh Shreevastav, UPPLANDS VÄSBY (SE); Gunnar Mildh, SOLLENTUNA (SE); Antonino Orsino, KIRKKONUMMI (FI); Marco Belleschi, SOLNA (SE); Boris Dortschy, VENDELSÖ (SE); Lei Bao, GÖTEBORG (SE); Paul Schliwa-Bertling, LJUNGSBRO (SE)

(21) Appl. No.: 18/874,227

(22) PCT Filed: Jun. 14, 2023
(86) PCT No.: PCT/IB2023/056170

§ 371 Date: Dec. 12, 2024

Related U.S. Application Data
(60) Provisional application No. 63/351,852, filed on Jun. 14, 2022.

(51) Int. Cl. H04W 36/08; H04W 36/00; H04W 36/30; H04W 76/20; H04W 92/24

(52) U.S. Cl. CPC H04W 36/087; H04W 36/0058; H04W 36/30; H04W 76/20; H04W 92/24

(57) ABSTRACT

There is provided a method performed by a mobile Integrated Access Backhaul (mIAB) node, which comprises a mobile IAB (mIAB)-Mobile Termination (MT) and a mIAB-Distributed Unit (DU). The method comprises connecting to a first network node with the mIAB-MT; and connecting to a second network node with the mIAB-DU, the first network node being different from the second network node. A mobile IAB node is also provided for implementing this method.

### RELATED APPLICATIONS

This application claims the benefits of priority of U.S. Provisional Patent Application No. 63/351,852, entitled “Method for IAB-node mobility with anchor CU” and filed at the United States Patent and Trademark Office (USPTO) on Jun. 14, 2022.

### TECHNICAL FIELD

This application generally relates to wireless communications and more specifically to methods and nodes for IAB-node mobility with anchor CU.

### BACKGROUND

### Integrated Access Backhaul (IAB) Architecture (Release-16)

IAB is based on the Centralized Unit (CU)-Distributed Unit (DU) split that was standardized in Release 15. The CU is in charge of the radio resource control (RRC) and the packet data convergence (PCDP) protocol, whereas the DU is in charge of the radio link control (RLC) and medium access control (MAC). The F1 interface connects the CU and the DU. The CU-DU split facilitates separate physical CU and DU, while also allowing a single CU to be connected to multiple DUs. For example, FIG. 1 shows the basic architecture of IAB in Stand-alone (SA) mode.

FIG. 1 illustrates a single IAB donor connected to the core network. The IAB donor serves three direct IAB child nodes through two collocated DUs at the donor for wireless backhauling. The center IAB node in turn serves two IAB nodes through wireless backhaul. All IAB nodes in the figure backhauls traffic both related to User Equipments (UEs) connected to it, and other backhaul traffic from downstream IAB nodes.

The main components of the IAB architecture are:
1) IAB-node: A node that provides wireless access to the UEs while also backhauling the traffic to other nodes. The IAB node consists of a DU that provides access to connected UEs and a mobile termination (MT) that connects to other IAB nodes or donors in the uplink direction for backhaul.
2) IAB-donor: A node that provides UEs an interface to the core network and wireless functionality to other IAB-nodes to backhaul their traffic to/from the core network.

The defining feature of IAB is the use of wireless spectrum for both access of UEs and backhauling of data through IAB-nodes. Thus, there needs to be clear coordination of access and backhaul resources to avoid interference between them.

In Release 16 (Rel-16), IAB was standardized with basic support for multi-hop multi-path backhaul for directed acyclic graph (DAG) topology, i.e., no mesh-based topology was supported. Rel-16 also supports Quality of Service (QoS) prioritization of backhaul traffic and flexible resource usage between access and backhaul. Discussions in Rel-17 are on topology enhancements for IAB with partial migration of IAB-nodes for Radio Link failure (RLF) recovery and load balancing.

FIG. 2 shows the adjacent upstream node which is closer to the IAB donor node of an IAB node, which is referred to as a parent IAB-node of the IAB-node. The adjacent downstream node which is further away from the IAB donor node of an IAB node is referred to as a child node of the IAB-node. The backhaul link between the parent IAB-node and the IAB-node is referred to as parent (backhaul) link, whereas the backhaul link between the IAB-node and the child node is referred to as child (backhaul) link.

### F1 Interface

The F1 interface connects the CU to the DU in the split architecture which is also applicable to the IAB architecture. The F1 interface connects the CU from an IAB donor to IAB-DU in the IAB-nodes. The F1 interface also supports control and user plane separation through F1-C and F1-U respectively.

This interface holds even during IAB mobility where an IAB node moves and connects to parent/donor IAB nodes. In such a scenario the DU present in the mobile IAB node connects to the CU present in the IAB donor.

The IAB-DU initiates a F1 setup with the IAB-CU with which it has a Transport Network Layer (TNL) connection and the initial F1 setup is shown below from section 8.5 of 3GPP TS 38.401 v17.0.0 [Error! Reference source not found.]. Once the F1 setup is completed, the IAB donor CU sends a GNB-CU CONFIGURATION UPDATE to optionally indicate the DU cells to be activated.

FIG. 3 shows the F1 setup and cell activation in a SA 5G network, for example.

### Backhaul (BH) RLC Channel Concept (Rel-16)

BH RLC channels are used for transporting packets between IAB nodes (or between an IAB-donor DU and an IAB node). When it comes to the mapping between UE radio bearers and backhaul RLC channels, two types of mappings are supported, namely N:1 and 1:1 mapping. The N:1 mapping multiplexes several UE radio bearers onto a single BH RLC channel based on specific parameters, such as QoS profile of the bearers. The N:1 mapping is designed for optimal use of BH RLC channels and requires less signaling overhead as a small number of BH RLC channels need to be established. The 1:1 mapping, on the other hand, maps each UE radio bearer onto a separate BH RLC channel, and is designed to ensure fine QoS granularity at UE radio bearer level. 1:1 mapping requires more backhaul RLC channels and more signaling overhead to setup and release BH RLC channels, one for each hop, for each UE radio bearer.

### Inter-Donor Topology Redundancy (Rel-17) and Partial Migration

The inter-CU topological redundancy procedure enables the establishment, modification, and release of redundant paths in IAB-topologies underneath different IAB-donor-CUs. Since topological redundancy uses New Radio (NR)-Dual Connectivity (DC) for the IAB-MT, it is only supported for IAB-nodes operating in the SA mode.

FIG. 4 shows an IAB-node IAB3 in IAB inter-donor topology redundancy. Indeed, IAB3 is connected to CU1 and CU2. In an inter-CU topological redundancy topology a second path for the F1 connection of the dual-connecting IAB-node (e.g. IAB3) with the F1-terminating IAB-donor-CU is established in the topology of the non-F1-terminating IAB-donor-CU. By retaining the F1-connection of the dual-connecting IAB-node's IAB-DU with the F1-terminating IAB-donor-CU and having a second RRC connection for the dual-connecting IAB-node's IAB-MT with the non-F1-terminating IAB-donor-CU, this procedure renders the dual-connecting IAB-node as a boundary IAB-node.

The traffic offloaded through the inter-CU topology adaptation described above (including the offloaded traffic pertaining to the migrating IAB-node and its descendant IAB-nodes and their served UEs) can be fully revoked. In this case, the migrating IAB-MT is handed over in reverse direction, i.e., from the non-F1-terminating IAB-donor-CU to the F1-terminating IAB-donor-CU, and the traffic of the migrating IAB-DU and the descendant IAB-DUs is routed again along the former source path.

The non-F1-terminating IAB-donor-CU can trigger the full traffic revoking by executing the XnAP Handover Preparation procedure for the migrating IAB-MT towards the F1-terminating IAB-donor-CU. The F1-terminating IAB-donor-CU can trigger the full revoking of traffic offload by requesting the release of all offloaded traffic from the non-F1-terminating IAB-donor-CU through the IAB TRANSPORT MIGRATION MANAGEMENT REQUEST towards the non-F1-terminating IAB-donor-CU. These messages trigger the XnAP Handover Preparation procedure for the migrating IAB-MT towards the F1-terminating IAB-donor-CU.

The F1-terminating IAB-donor-CU may request full or partial release of the offloaded traffic from the non-F1-terminating IAB-donor-CU via the IAB TRANSPORT MIGRATION MANAGEMENT REQUEST message.

### Mobile IAB (mIAB) (Rel-18)

In Rel-18, it is expected that the different Radio Access Network (RAN) groups will work towards enhancing the functionality of IAB with focus on mobile-IAB providing 5G coverage enhancement to, e.g., UEs onboard of a bus, and surrounding UEs.

The initial use cases for mIAB are expected to be based on 3GPP TR 22.839.

One of the main use cases of mIAB cell is to serve the UEs which are residing in a vehicle with the vehicle mounted relay. Other relevant use cases for mobile IABs involves a mobile/nomadic IAB network node mounted on a vehicle that provides extended coverage. This involves scenarios where additional coverage is required during special events like concerts, during disasters. The nomadic IAB node provides access to surrounding UEs while the backhaul traffic from the nomadic IAB node is then transmitted wirelessly either with the help of IAB donors or Non-terrestrial networks (NTN). A nomadic IAB node also reduces or even eliminates signal strength loss due to vehicle penetration for UEs that are present in the vehicles.

Advantages of Mobile IAB can include: reducing/eliminating the vehicle penetration loss (specially at high frequency); and reducing/eliminating group handover.

Most use cases of mIAB can be expected to be mounted on public transport vehicles and to move to a large extent in a pre-determined route. FIG. 5 shows one such mobile IAB mounted on a bus travelling on a route that is covered by 4 different parent IAB-nodes (IAB Parent 1,2,3,4). The parent nodes backhaul their traffic through 2 donor nodes (Donor IAB X and Y).

An IAB node has a DU that provides access to UEs around it and an MT that provides a backhaul connection of the IAB-node to its parent(s) and the rest of the network. The parent IAB-nodes consist of DUs that provide access to UEs and the mobile IAB present in their coverage. They also consist of MTs that backhaul traffic together with traffic from the mobile IAB node. Finally, the two donor nodes consist of DU that provides access and CU that is connected to the core network. The CUs in both donor nodes usually maintain a F1 connectivity to parent IAB-nodes that are served by respective donor nodes.

The mobile IAB node maintains an F1 connection to a donor (one donor at a time). In FIG. 5, the mIAB connects to the following nodes in the different positions as described below:

Position A: BH through parent node 1, F1 connection to donor node X

Position B: BH through parent node 2, F1 connection to donor node X

Position C: BH through parent node 3, F1 connection to donor node Y

Position D: BH through parent node 4, F1 connection to donor node Y

The mobile IAB must change the F1 connection from donor X to donor Y when moving from position B to C, thus requiring a F1 handover and setup of backhaul RLC channels.

### SUMMARY

There currently exist certain challenge(s). During the 3GPP Rel-17 IAB work item, it was proposed to enable the full inter-donor migration (which is, de facto, mobility) of an IAB node, by handing over its IAB-MT part, followed by handing over the IAB-DU part and the connected UEs and IAB nodes to the target donor. This approach tightly couples the handover of the IAB-MT and the IAB-DU part of the IAB node. The drawbacks of this approach are:
A large processing and signaling load over the Xn or NG interfaces every time a mobile IAB node changes its serving donor, where the contexts of the mobile IAB-MT, mobile IAB-DU, all the devices served by the mobile IAB node, as well as the configuration of BH RLC channels from the old parent to the mobile IAB-MT need to be transferred to the target donor. This high signaling and processing load caused by IAB node mobility can be prohibitive, especially in case of frequent handovers between donors. The procedure will also be very complex which increases the risk of errors leading to service interruption.
Long service interruption, given that new cells would need to be set up on the DU of the mobile IAB-node at every handover and that all the served UEs would need to have their security keys updated, before being able to transmit and receive data under the target donor after the migration.
The fact that the mIAB may stay under one donor for just a little while may be acceptable for the mIAB-MT, but not for the mIAB-DU. In that situation, it may happen that, yet another handover happens before the first mIAB-DU handover has been completed, and everything remains in an undetermined state of F1 connectivity.

Certain aspects of the disclosure and their embodiments may provide solutions to these or other challenges.

In this disclosure, a mechanism is provided where a dedicated CU anchor (terminates) the F1AP protocol of the IAB-DU part of the mobile IAB node (and thus handles all devices connected to the IAB-DU part), whereas the IAB-MT part co-located in the same mobile IAB node is handed-over to a target CU (i.e. the RRC connection of the mobile IAB node is handed-over from the source CU to the target CU); wherein:
the IAB-MT part of the mobile IAB node is performing a handover from a source cell controlled by a source CU to a target cell controlled by a target CU, or it reestablishes its RRC connection to the target CU after a radio link failure in a cell hosted by the source CU;
the anchor CU is a network node different from the source CU and the target CU of the mobile IAB-MT node being handed over, or reestablishing to a cell hosted by the target CU. The anchor CU handles the F1 connectivity of the mobile IAB node;
the anchor CU and the target CU may or may not have a direct Xn connection and the F1 protocol carrying control or user data is either sent via NGAP (via AMF) or via NG-U (UPF) or can be sent by cascaded (multi-hop) Xn if there is no direct Xn between the anchor CU and the target CU;
the necessary information to establish a connection between the anchor CU and target CU would be provided by means of intermediate CU(s), wherein the intermediate CU may be a source CU. If the intermediate node is the source CU, additional information may be provided between the source CU and target CU indicating that the IAB DU part of the migrating IAB node is connected to an anchor CU different than the source CU (the information can include addressing information of the anchor CU or other information).
the necessary actions to determine, based on the information exchange, whether to retain the F1AP connectivity at the anchor CU or to move it to the target CU.

For example, FIG. 6 illustrates that the F1AP protocol 10 is terminated in Anchor CU 12 even though the mobile IAB MT 14 is handed over to Target CU 16 (second CU or second Network (NW) node) which may or may not have an Xn with Anchor CU 12. The IAB-MT 14 part of the mobile IAB node is handed over to the target CU 16 (i.e., its RRC connection is handed over to the target CU 16) or reestablished to a cell hosted by the target CU 16, wherein the IAB-DU 18 part of the mobile IAB node is retained at the anchor CU 12. Note that the F1AP connection in FIG. 6 is a logical connection that physically may be transmitted via other nodes.

The solution enables reducing the number of migrations for the mobile IAB-DU, by enabling decoupling from the handover of the collocated mobile IAB-MT.

For example. there is provided a method performed by a mIAB node. The method comprises: connecting to a first network node with the mIAB-MT; and connecting to a second network node with the mIAB-DU, the first network node being different from the second network node. A mIAB node, comprising a mIAB-MT and a mIAB-DU, and comprising processing circuitry and memory, is also provided to perform this method.

There is also a method performed by a first network node (e.g. CU1), which comprises: establishing a connection with a mIAB-MT; and receiving a request from a second network node, the request comprising parameters for setting up backhaul resources, wherein the mIAB-DU is connected to the second network node. A first network node (e.g. CU1), comprising processing circuitry and memory, is also provided to perform this method.

There is also provided a method at a second network node (e.g. an anchor node), which comprises: establishing a connection with the mIAB-DU; and sending a request to a first network node, the request comprising parameters for setting up backhaul resources, wherein the mIAB-MT is connected to the first network node. A second network node, such as the anchor node, comprising processing circuitry and memory, is also provided to perform this method.

Still yet, a method in a communication system comprising a first network node (e.g. CU1), a second network node (e.g. anchor CU), a third network node (e.g. CU2) and a mIAB node including a mIAB-MT and a mIAB-DU is provided. The method comprises: the mIAB-MT establishing a connection with the first network node; the mIAB-DU establishing a connection with the second network node; the second network node exchanging messages with the first network to set up backhaul resources for the mIAB node; and the first network node determining that the mIAB-MT needs to be handed over to a third network node, wherein the mIAB-DU stays connected with the second network node.

Certain embodiments may provide one or more of the following technical advantage(s).
Reduce NW complexity by avoiding the change of anchoring CU for the F1AP;
Allows operators to deploy mIAB without having to have Xn link between all CUs;
Allows a target CU to interact with an anchor CU, e.g., to exchange information about resource configuration for the IAB node.

### BRIEF DESCRIPTION OF THE DRAWINGS

Exemplary embodiments will be described in more detail with reference to the following figures, in which:

FIG. 1 illustrates an example of a Reference diagram for IAB-architectures (SA mode).

FIG. 2 illustrates an example of IAB terminologies in adjacent hops.

FIG. 3 illustrates an example of F1 setup and cell activation from in a SA 5G network.

FIG. 4 illustrates an example of IAB inter-CU topology redundancy.

FIG. 5 illustrates an example of Mobile IAB-Node which involves Intra-Donor, Inter-Donor (same CU) and Inter CUs.

FIG. 6 illustrates an example of a F1AP protocol terminated in Anchor CU even though the mobile IAB MT is handed over to second CU.

FIG. 7 illustrates an example of an Intra-donor migration in rel-16.

FIG. 8 illustrates an example of Inter-donor migration in Rel-17.

FIG. 9 illustrates an example of migration between non-F1 terminating CUs in Rel-18.

FIG. 10 illustrates an example of a signal diagram in which the decision on whether the F1 connectivity of the mobile IAB node can be retained to the anchor CU or if that should be moved to the target CU (i.e., second network node) is performed by the target CU.

FIG. 11 illustrates an example of a signal diagram in which the decision of whether to retain the F1 connectivity at the third network node, anchor CU, is first determined by the anchor CU, and then by the target CU, second network node, on the basis of the information indicated by the source CU, first network node.

FIG. 12 illustrates an example of a signal diagram for a handover of a mIAB-MT and a migration of the mIAB-DU, in a communication network.

FIG. 13 illustrates an example of a flow chart of a method at mIAB node, according to an embodiment.

FIG. 14 illustrates an example of a flow chart of a method at a first network node, according to an embodiment.

FIG. 15 illustrates an example of a flow chart of a method at a second network node, according to an embodiment.

FIG. 16 shows an example of a communication system, according to an embodiment.

FIG. 17 shows a schematic diagram of a UE, according to an embodiment.

FIG. 18 shows a schematic diagram of a network node, according to an embodiment.

FIG. 19 illustrates a block diagram illustrating a virtualization environment.

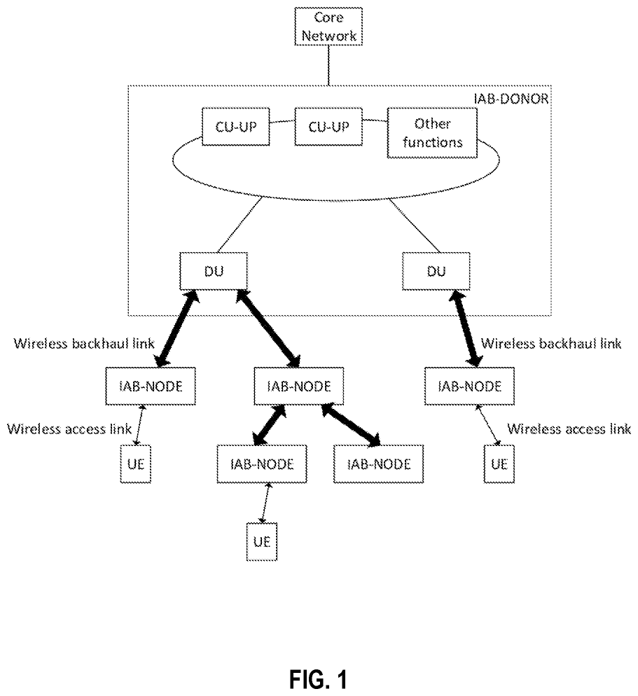

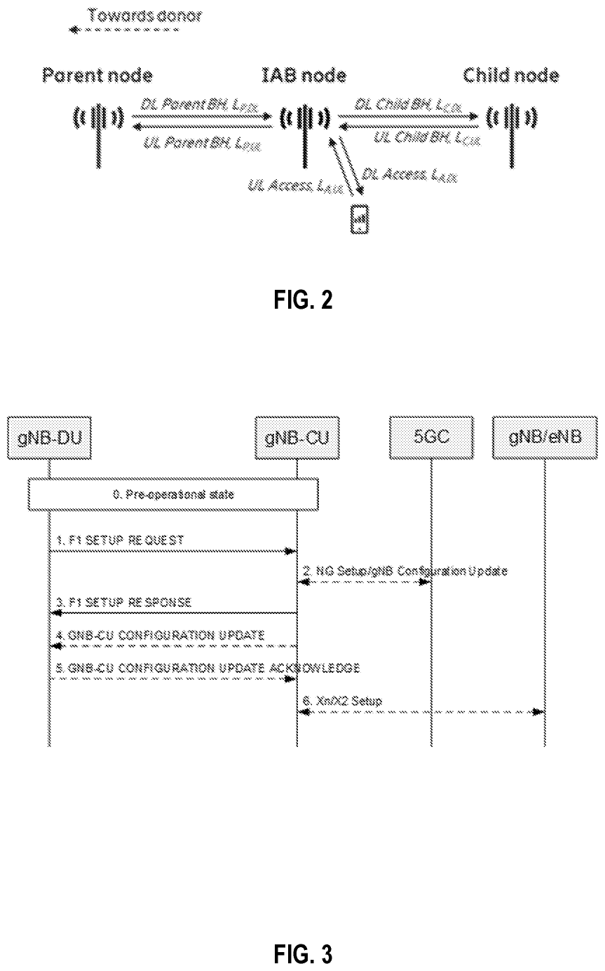

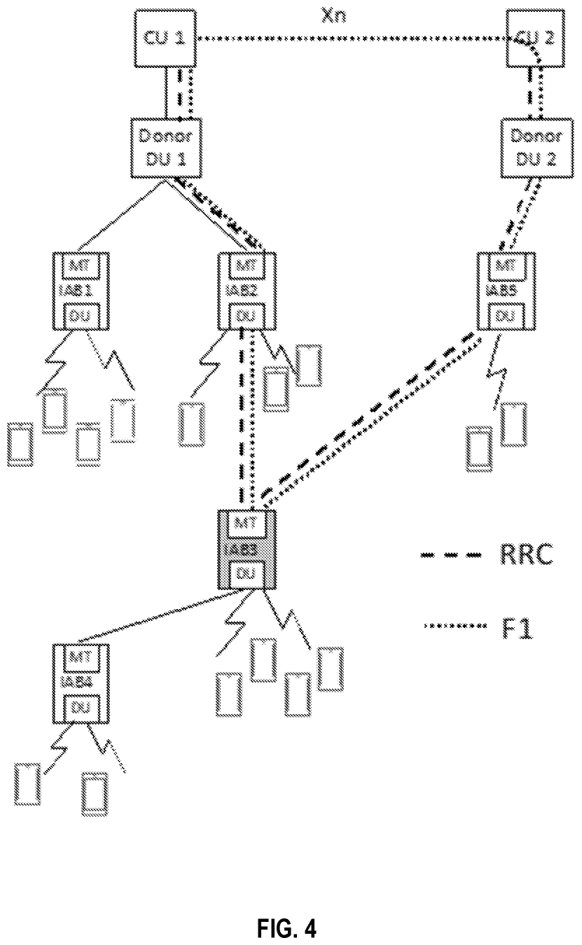

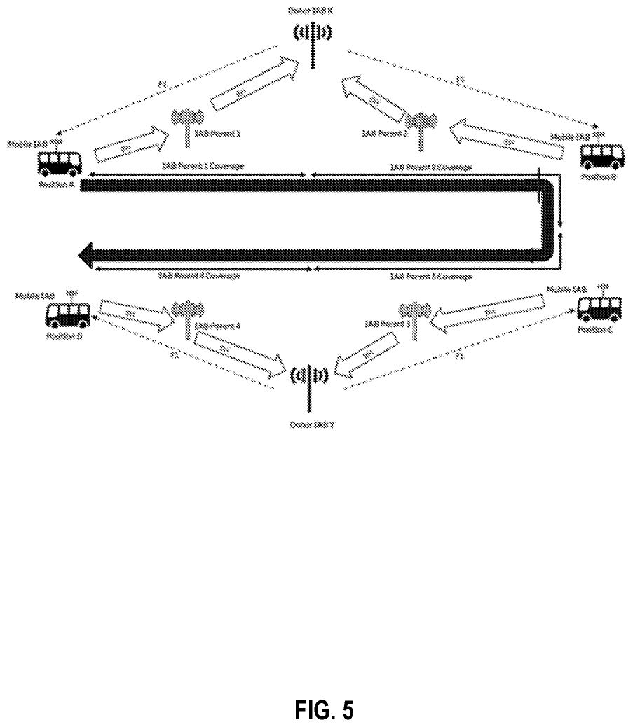

### DETAILED DESCRIPTION

Some of the embodiments contemplated herein will now be described more fully with reference to the accompanying drawings. Embodiments are provided by way of example to convey the scope of the subject matter to those skilled in the art.

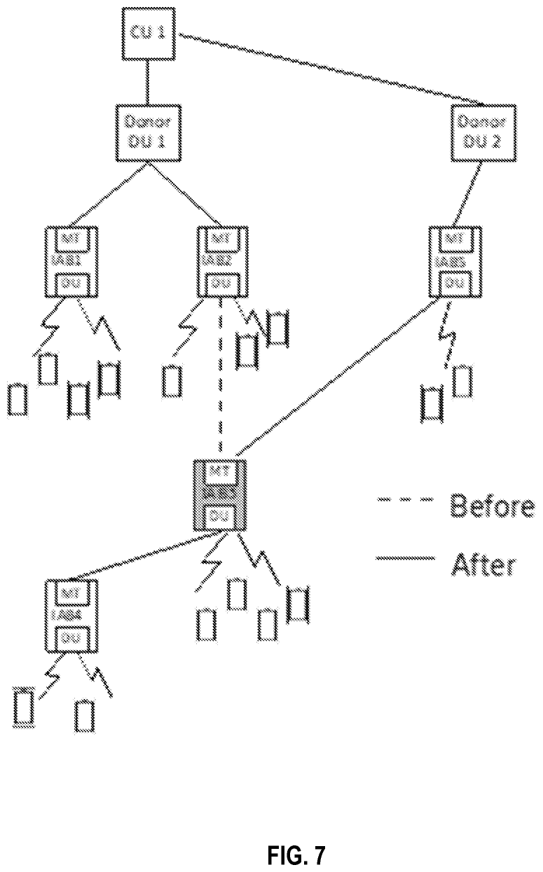

FIGS. 7 to 9 illustrate the evolution steps of the migration of an IAB node in Rel-16 to Rel-18. For example, FIG. 7 shows an example of an intra-donor migration in Rel-16, where IAB3 moves from a path connected to donor DUI to a path connected to donor DU2. Donor DU1 and donor DU2 are both connected to CU1.

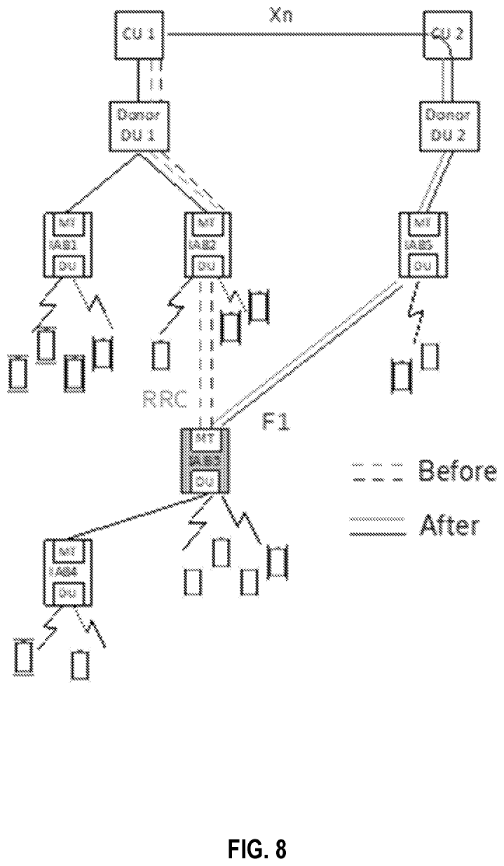

FIG. 8 illustrates an example of an inter-donor migration in Rel-17, where IAB3 moves from a path connected to CUI (dashed lines) to a path connected to CU2 (solid lines). After the migration, IAB3-DU is/remains F1-connected to CU1 via CU2.

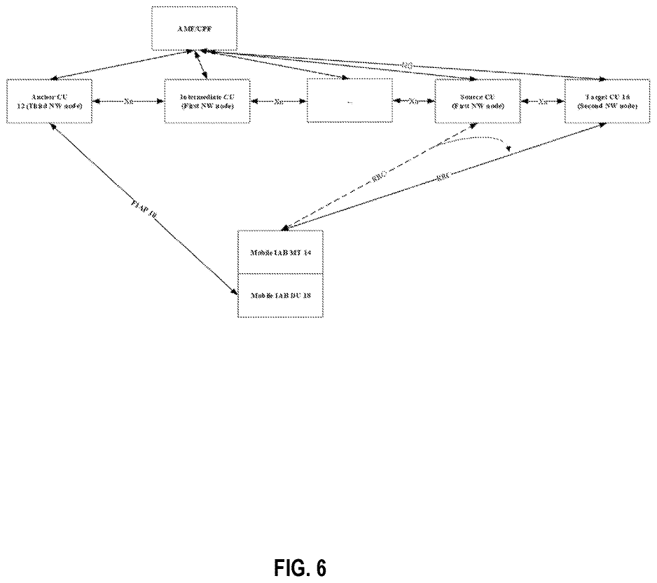

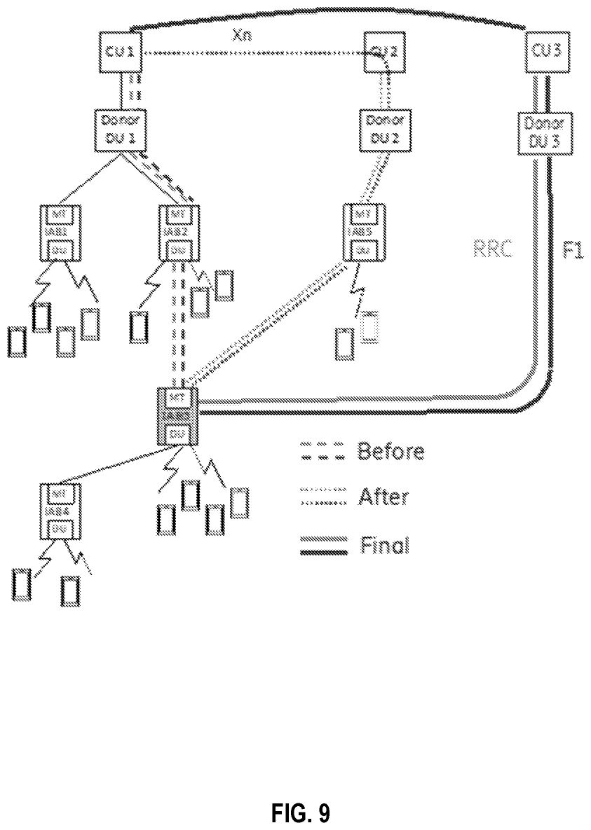

FIG. 9 illustrates an example of a migration between non-F1 terminating CUs in Rel-18. For example, after the migration of FIG. 8, IAB3 can decide to migrate to another CU, e.g. CU3. In this case, the handover (HO) or migration of the MT and DU of IAB3 can be done separately. Furthermore, as shown in FIG. 6, the RRC connections of IAB-MT can be migrated from the source CU to the target CU. The F1AP connection of IAB-DU could also be migrated from an anchor CU to the target CU. As a note, a non-F1 terminating CU is a CU that does not have a F1 connection with another node (e.g. a IAB-DU of the migration node (i.e. MT handover). A non-F1 terminating CU is a CU that only terminates RRC.

Also, note the difference in terminology between a CU that terminates F1 (CU connected to DU) and a CU terminating RRC (CU serving MT). A same node/CU can have F1 and RRC terminating connection, but it does not have to. The nodes can be different (i.e. a node for the F1 terminating connection and a different node for the RRC terminating connection).

In FIG. 9, before and after the MT HO from CU2 to CU3, the F1 of the DU3 is always terminated at CU1 (though tunneled through CU2 and CU3). CU2 and CU3 never terminate F1 in this scenario: migration/HO between non-F1 terminating CUs (CU2 and CU3).

The embodiments of this disclosure are related to the migration example of FIG. 9 and will be described next. But first, the different nodes used in the embodiments will be described.

A first network node can be an intermediate IAB node between the anchor CU and the target CU for the mobile IAB node (e.g. mIAB-MT) that is handed over. The first network node may be also a source CU for the mobile IAB node that is handed-over, or the source CU for the mobile IAB node before experiencing a connection failure in the source CU, or the CU to which the IAB node connects, e.g. after entering connected mode.

A second network node can be the target CU for the MT of the mobile IAB node. The target CU may be the node to which the IAB node (e.g. mIAB-MT) is handed-over, or the CU to which the IAB node (e.g. mIAB-MT) reestablishes its connection, e.g. after a radio link failure in the source CU.

A third network node can be the anchor CU which controls the F1 connectivity of the mobile IAB node.

A fourth network node can be a mobile IAB node whose IAB-MT part is connected to the first network node (i.e., RRC context of the mobile IAB-MT is handled by the first network node), and whose IAB-DU part is controlled/anchored to the third network, i.e., anchor CU (i.e. the F1 connectivity of the IAB-DU part is handled by the anchor CU).

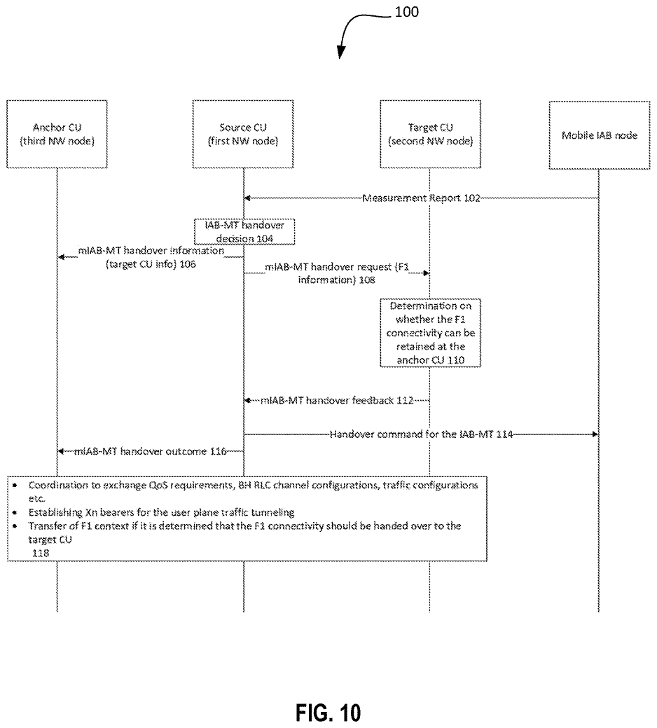

Now turning to FIG. 10, an example of a flow chart 100 in which an IAB node (e.g. MT) is migrated from a source CU to a target CU will be described. FIG. 10 also illustrates the decision on whether the F1 connectivity of the mobile IAB node can be retained at the anchor CU or if that should be moved to the target CU (i.e., second network node). This decision can be performed by the target CU.

In step 102 of FIG. 10, the mobile IAB node sends a measurement report 102 to the source CU. Based on this measurement report, the source CU can decide to do a handover of the IAB-MT in step 104. In step 106, the source CU sends the handover information, such as information regarding the target CU, to the anchor CU. In step 108, the source CU sends a handover request to the target CU. The handover request can comprise F1 information. In step 110, the target CU can determine whether the F1 connectivity can be retained at the anchor CU or not. The determination can be based on different criteria/conditions. For example, the target CU can determine whether it can tunnel F1, or not. If not, F1 cannot be retained at the anchor CU, thus the F1 connectivity needs to be migrated to the target CU (to which the IAB-MT is handed over). In step 112, the target CU sends a handover feedback to the source CU. Once acknowledged, the source CU sends a handover command to the mobile IAB in step 114. In step 116, the source CU sends a handover outcome to the anchor CU, the handover outcome can comprise the result of the determination of step 110. In step 118, the anchor CU and the target CU can communicate with each other to:
1) coordinate exchange of QoS requirements, BH RLC channel configurations, traffic configurations, etc.;
2) establis Xn bearers for the user plane traffic tunneling;
3) transfer of F1 context if it is determined that the F1 connectivity should be handed over to the target CU.

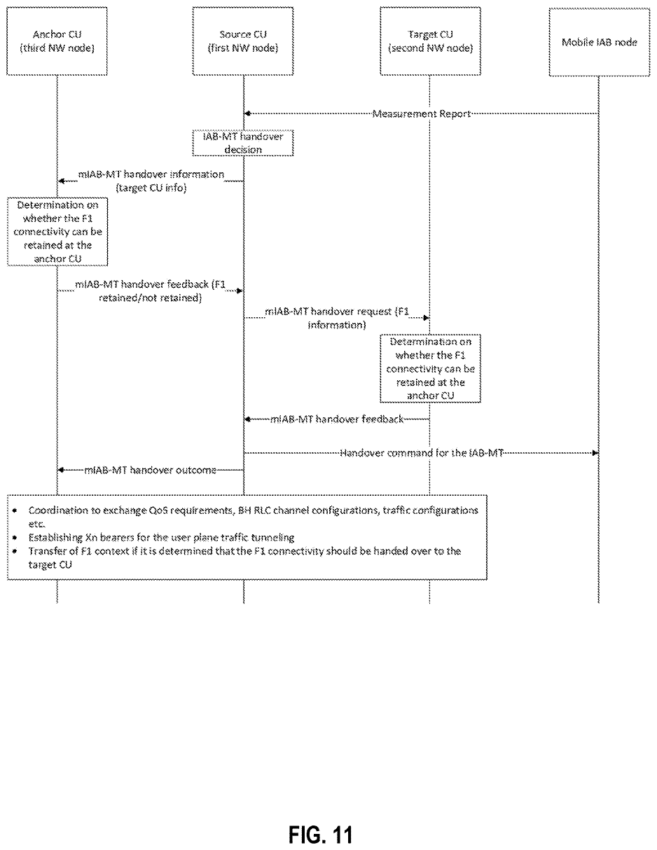

FIG. 11 is similar to FIG. 10 but the decision of whether to retain the F1 connectivity at the anchor CU (third network node) is first determined by the anchor CU, and then by the target CU (second network node), on the basis of the information indicated by the source CU (first network node).

Based on FIGS. 10 and 11, the following methods can be contemplated:

Methods for the first network node (which may contain the source CU), to inform via a message the third network node of a handover to be triggered for the mobile IAB node (fourth network node) towards the second network node. This message may contain the information associated to the second network node (e.g. the gNB ID of the third network node). For example, the message can comprise the IAB-MT information message (in step 106) of FIGS. 10 and 11).

Methods for the first network node, which is the source CU, to inform via a message the second network node of a handover for the mobile IAB node towards the second network node, where the information may indicate that the IAB-DU of the fourth network node is anchored at the third network node. The information can be sent as part of the handover preparation message, such as the mIAB-MT handover request in step 108 in FIG. 10), and it may contain the information associated with the third network node (e.g. the gNB ID of the third network node (anchor CU)). In an example, the information can be sent as part of the RRC context fetch procedure, in case for example the IAB node reestablishes to the second network node after a radio link failure in the first network node.

Methods for the first network node, which is the source CU, to indicate to the anchor CU that upon the handover to the second network node, the F1 connectivity of the mobile IAB node can be retained at the anchor CU or that the F1 connectivity should be handed over to the second network node (the target CU). This method is performed upon receiving feedback from the second network node on whether the F1 connectivity of the mobile IAB node can be retained at the anchor CU or whether that should be handed-over to the third network node. The message indicating whether to retain the F1 connectivity at the anchor CU or whether it should be handed-over to the third network node can correspond to the mIAB-MT handover outcome message 112 in FIG. 10.

Methods for the first network node, which is an intermediate CU, to forward messages from the anchor CU (third network node) to the target CU (second network node). This message can be used to transfer the F1 connectivity from the anchor CU to the target CU, if no Xn is available between the anchor CU and the target CU.

Methods at the second network node for determining on the basis of the information received from the first network node on whether the IAB-MT part of the mobile IAB node can be handed over to the second network node, while the IAB-DU part of the mobile IAB node and the associated F1 connectivity can be retained at the anchor CU (third network node). The decision can for example depend on whether there is an Xn connectivity between the third network node and the anchor CU (this can be known by inspecting the ID of the CU (e.g., gNB ID) indicated by the first network node as per the previous/above methods. In another example, the determination may be performed for an IAB node that attempts reestablishment in the second network node after radio link failure in the first network node.

Methods at the second network node for signaling to the source CU (first network node) the determination performed in the above method (see mIAB-MT handover feedback message 112 in FIG. 10).

Methods at the second network node for signalling to the anchor CU, e.g., if there is Xn connectivity, the determination performed in the above method. In case it is determined that the IAB-DU part of the mobile IAB node can be retained at the anchor CU, this signalling may also contain information to initiate an Xn tunneling of user plane data between the second network node and third network node (anchor CU).

Methods at the second network node for exchanging between the second network (NW) node and the third network node (anchor CU) the QoS requirements needed for the mobile IAB node, the BH RLC channel configuration properties, etc.

Methods performed at the third network node (anchor CU) to determine whether to hand-over the F1 connectivity of the mobile IAB node from the first network node to the second network node. The determination can be performed on the basis of the information received by the first network node or by the second network node as described in the above methods.

Methods at the third network node to initiate transfer of the F1 context to the second network node, if it is determined in some of the above steps/methods that the F1 connectivity of the mobile IAB node should be moved to the second network node. This message may involve the first network node if no Xn connectivity is present between the target CU and the anchor CU.

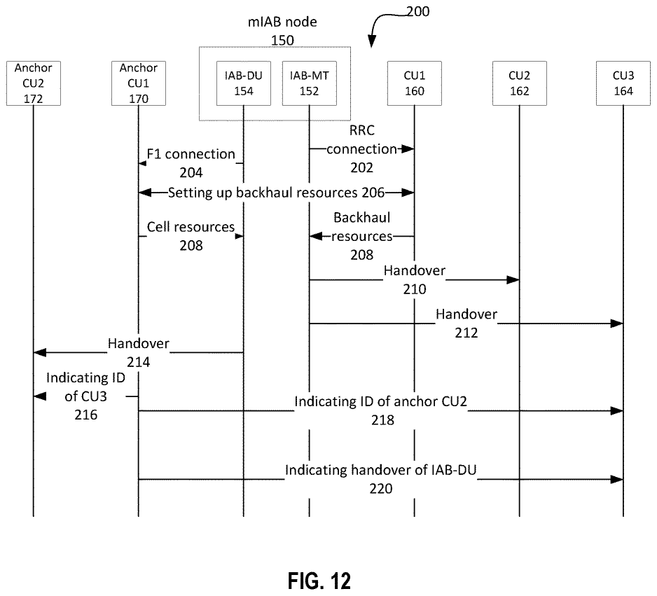

Now a detailed example of sequences for a method 200 for implementing the migration of a mobile IAB node in Rel-18 will be given, with reference to FIG. 12 and according to some embodiments. FIG. 12 shows a mIAB node 150, comprising a mIAB-MT 152 and a mIAB-DU 154, a CUI 160, a CU2 162 and a CU3 164, an anchor Cul 170 and an anchor CU2 172.

Step 202: Mobile IAB-MT establishes an RRC connection with the first donor CU First, the IAB-MT part of the mobile node (herein referred to as the mIAB-MT 152) performs an initial access to the network and connects via RRC to a donor CU, herein referred to as the first CU 160. During the connection establishment, the first CU realizes that the IAB-MT is a mobile IAB-MT by means of, e.g., an explicit indication from the mIAB-MT, an implied indication (e.g., the RRC connection is established on a specific logical channel ID reserved only for the mobile IAB), or by means of an indication from the Operation Administration and Management (OAM).

### Step 204: Mobile IAB-DU Establishes an F1 Connection with Anchor CU

After realizing that the MT is an mIAB-MT, the mIAB-MT 152 is provided with the parameters needed for the IAB-DU part of the mobile IAB node (herein referred to as the mIAB-DU) to establish one or more TNL associations, IPsec tunnel(s), and the F1 connectivity to a donor CU different than the first CU, herein referred to as the anchor CU (e.g. anchor CUI in FIG. 12).

For example, the first CU can provide the above parameters to the mIAB-MT via RRC signaling, e.g., during the IP address allocation procedure for the mIAB-MT.

In one variant, the parameters needed for the mIAB-DU to establish one or more TNL associations, IPsec tunnels and the F1 connectivity to the anchor CU 170 can be configured to the mIAB-DU by the OAM.

In another variant, the mIAB-MT receives the parameters from the first CU, and passes them to the mIAB-DU, which then establishes TNL association(s), IPsec tunnel(s) and IPsec security associations, and F1 connectivity to the anchor CU.

Examples of configuration parameters are, e.g., the (inner and outer) internet protocol (IP) address(es) of the anchor CU, the IP address(es) of the mIAB-DU.

In another variant, the mIAB-DU is not provided with any detailed addressing information to establish F1, instead it just sends a request to the first CU and the first CU then adds the relevant addressing information needed to setup the F1 connection to the anchor CU.

In one variant, the first CU can send an enquiry message to the anchor CU (e.g., via the X2/Xn interface) in order to acquire the necessary parameters and information for the mIAB-DU to establish an F1 connection with the anchor CU. Once the anchor CU replies to the first CU, the first CU provides such parameters or configuration to the mIAB-MT (e.g., via RRC signaling).

In one example, the anchor CU can be a dedicated CU, used to serve all mIAB-DUs in an area. In another example, the first CU and anchor CU can be the same CU.

So, similar to legacy specifications, the F1 connection setup first requires the setup of one or more TNL associations, and, optionally, one or more IPsec tunnels between a CU and a DU. During the process of TNL, IPsec and F1 setup between the mIAB-DU and the anchor CU, the packets sent from the mIAB-DU 154 arrive at the donor-DU of the first CU (herein referred to as the first D-DU), by means of BAP routing from the mIAB node via its ancestor nodes. The first D-DU then forwards the packets towards the anchor CU by means of IP routing. So, as long as the mIAB-MT 152 is connected to the first CU and the mIAB-DU is connected to the anchor DU, the packets exchanged between the mIAB-DU 154 and the anchor CU are transported via the D-DU controlled by the first CU. Herein, to route the packets to/from the mIAB node properly, the first D-DU must be configured by the first CU or by the OAM, with one or more of the following:
The IP routing table entries for routing the IP traffic between the anchor CU and the mIAB-DU;
List of IP addresses/prefixes that are exempt from discarding at the first D-DU. According to current specifications, each donor-DU (D-DU) has its own IP domain, and it may discard the packets with the source IP address pertaining to another IP address domain. Hence, the first D-DU must be configured with the list of IP addresses/prefixes that are exempt from discarding. These IP addresses are used as source IP addresses in the packets sent from the mIAB-DU to the anchor CU and destination IP addresses in the packets sent from the anchor CU to the mIAB-DU, where the anchor CU and the first CU belong to different IP address domains.

After setting up the IPsec tunnel(s) and TNL association(s) between the mIAB-DU and anchor CU, the mIAB-DU sends the F1 SETUP REQUEST to the anchor CU. After receiving the F1 SETUP REQUEST from the mIAB-DU, the anchor CU replies with the F1 SETUP RESPONSE, and configures the mIAB-DU with the parameters needed for the mIAB-DU to operate and serve UEs.

### Step 206: Coordination between the Anchor CU and the First CU for Setting Up Backhaul

The anchor CU 170 informs the first CU, e.g., directly (via XnAP), or indirectly (via AMF, by using NGAP signaling), about the backhaul resources needed to serve the mIAB node and its served UEs. The coordination information conveyed to the first CU can be, e.g.:
The number of BH RLC channels needed to be established towards the mIAB-MT.
The QoS and/or the priority of each of these BH RLC channels.
The capacity needed for each of these BH RLC channels.
The number and type of IP addresses/IP address prefixes needed. Alternatively, the mIAB-MT may indicate to the CU that it is connecting to during the RRC connection setup what number and type of IP addresses are needed.
The capability of the mIAB and/or anchor CU (e.g., the RRC version implemented by the anchor CU of what features the anchor CU supports).

The first CU may accept the request and send an acknowledgement to the anchor CU. In the response message, or in a separate message, the first CU may send to the anchor CU, e.g.:
The new IP addresses to be used by the mIAB-DU (optional, otherwise the mIAB-DU can inform the anchor CU about the IP addresses/prefixes by itself).
The physical layer configuration to be used for the cells served by the mIAB-DU, after which the anchor CU delivers this configuration to the mIAB-DU via F1AP. The physical layer configuration may include, e.g., timeslot configuration (e.g., downlink/uplink/flexible (DUF)), Resource Block (RB) set configurations, Hard/Soft/Non-available (HSNA) configurations, Synchronization Signal Block (SSB) transmission configurations (e.g., STC) etc.
A measurement configuration or frequencies to be used by the mIAB in measurement and relative reference signal configuration (such as SS/PBCH Block Measurement Timing Configuration (SMTC) or SSB transmission configuration of other stationary or mobile IAB nodes).

Alternatively, the first CU may partially accept the request, or it can reject it. In case of partial acceptance, the first CU may send a “counteroffer” to the anchor CU, indicating, e.g., the QoS that it is able to provide to the BH RLC channels for which the requested capacity, QoS and/or control plane channel priority cannot be provided.

### Step 208: First CU Sets Up the Backhaul Resources Towards the mIAB-MT, Anchor CU Configures the Cell Resources at the mIAB-DU

The first CU 160 configures the first D-DU and the ancestors of the mIAB node with the backhaul resources and BAP routing entries for serving the mIAB node and establishes one or more BH RLC channels between the mIAB-MT and its parent node, and, if needed, between the ancestors of the mIAB node.

### Step 210: mIAB-MT is Handed Over from the First CU to a Second CU, mIAB-DU Remains Connected to the Anchor CU

The methods disclosed in this step may be applicable to the scenario of a mobile IAB node that is being handed over from the first CU 160 to the second CU 162, or for the scenario of a mobile IAB node that reestablishes its connection to the second CU 162 after radio link failure experienced in the first CU.

The mobile node moves within the area of the anchor CU 170, and, during that time, the mIAB-MT may be handed over from the first CU to another CU, e.g., second CU, or it may reestablish its connection with the second CU. Meanwhile, the mIAB-DU remains connected to the anchor CU.

As a part of HO signalling (e.g., XnAP or NGAP) for the HO of the mIAB-MT, the first CU indicates to the second CU that the mIAB-DU collocated with the mIAB-MT is anchored at another CU (i.e., anchor CU). Also, identifier(s) of the anchor CU can be provided to the second CU by the first CU, such as, e.g., Global gNB-ID, IP address(es), target ID etc. In a variant, the information is exchanged as part of the RRC context fetch procedure executed when the mobile IAB node reestablishes to the second CU after radio link failure in the first CU, i.e. the second CU requests the first CU to provide the RRC context associated to the mobile IAB node, and the first CU provides the above information.

When the first CU determines that the mIAB-MT should be handed over to the second CU, e.g. on the basis of the measurement reports received from the mobile IAB node, it notifies the anchor CU (e.g., directly via XnAP, or indirectly via NGAP via AMF(s)) that the handover (HO) of the mIAB-MT is about to take place. The first CU may also indicate to the anchor CU an identifier of the second CU (e.g., the gNB-ID, target ID and/or the IP address of the second CU) and the identifier(s) of the anchor CU to the second CU (e.g., the gNB-ID, target ID and/or the IP address of the anchor CU). For the case of reestablishment, this method may be performed by the second CU, i.e. the second CU may indicate to the anchor CU that the mobile IAB node is going to reestablish to the second CU, and that the F1 connectivity can be retained by the anchor CU or that it can be migrated from the anchor CU to the second CU.

On the basis of the received information, the anchor CU determines if the F1 connectivity should be also handed-over to the target CU. The decision can be based for example on whether the anchor CU has Xn connectivity already established with the target CU, or on the properties or measurements of the Xn interface, e.g. latency experienced over the Xn, packet losses, etc. Other methods to perform such determination at the anchor CU are disclosed in step 212 below.

In another variant, the second CU may also be in charge of determining whether the F1 connectivity should be moved to the second CU. For example, the target CU may determine whether the target CU has Xn connectivity already established with the anchor CU, on the properties or measurements of the Xn interface, e.g. latency experienced over the Xn, packet losses, etc. Other methods to perform such determination at the anchor CU are disclosed in the step 212 below.

Since the traffic between the mIAB-DU and the anchor CU will, from now on, traverse the donor DU served by the second CU (herein referred to as the second D-DU), the anchor CU and the second CU need to coordinate to establish the backhaul resources between the mIAB-MT and the second D-DU.

The coordination information can be exchanged, in multiple ways between the anchor CU and the CU serving the mIAB-MT, for example:
Via XnAP connection (if not existing at this point, a new XnAP connection can be set up between the anchor CU and the second CU, if it does not exist already). One advantage of setting up XnAP is that, as a part of the setup, the anchor CU will determine also the neighbors of the second CU. In such a case, existing XnAP messages or new XnAP messages can be used for the coordination between the second CU and the anchor CU.
Via NGAP signalling (e.g., RAN Information Management (RIM) transfer) or Configuration Transfer Procedure can be used to exchange the coordination information. In case of NGAP signalling, if the anchor CU and second CU are connected to the same AMF, the AMF acts as a relay for the messages. If they are connected with two different AMFs, then inter-AMF signalling is used to relay the messages.

Otherwise, the first CU can serve as a relay and forward the messages between the anchor CU and the second CU, in both directions.

In one variant, only the first or some of the coordination messages are exchanged via the first CU as the relay, while the remaining communication occurs directly between the anchor CU and the second CU.

In another variant, if the messages between the second CU and anchor CU are exchanged via the first CU (because there is no possibility of a direct connection between the anchor CU and the second CU), these messages are sent inside “containers” so that the first CU does not need to decode those messages but simply forward them transparently. For example, this message may be used to transfer the F1 context of the mobile IAB node from the anchor CU to the target CU when there is no Xn connectivity between the anchor CU and the target CU.

In another variant, the mIAB can be used as the “link” between the anchor CU and the second CU. For example, the mIAB-MT receives the configuration parameters from the second CU, the mIAB-MT passes the parameters to the co-located mIAB-DU, which then passes them to the anchor CU via F1AP (this may apply to both directions of the traffic).

The anchor CU needs to inform the second CU (in one of the ways mentioned above, via XnAP, NGAP or indirectly via first CU (or multiple intermediate CUs), about the backhaul resources needed to serve the mIAB node and its served UEs.

The coordination information conveyed from the anchor CU to the second CU can be, e.g.:
An explicit or explicit indication of whether the mIAB-DU is or is not being handed over;
The number of BH RLC channels needed to be established towards the mIAB-MT;
The QoS and/or the priority of each of these BH RLC channels;
The capacity needed for each of these BH RLC channels;
The number and type of IP addresses/IP address prefixes needed. Alternatively, the mIAB-MT may indicate to the CU that it is connecting to during the RRC connection setup the number and type of IP addresses needed; and/or
The capability of the mIAB and/or anchor CU (e.g., the RRC version implemented by the anchor CU of what features the anchor CU supports).

The second CU may accept the request (e.g. for backhaul resources needed) and send an acknowledgement to the anchor CU. In the response message, or in a separate message, the second CU may send to the anchor CU, e.g.:
The new IP address(es) to be used by the mIAB-DU (optional, otherwise the mIAB-DU can inform the anchor CU about the IP addresses/prefixes by itself); and/or
The physical layer configuration for the cells served by the mIAB-DU, after which the anchor CU delivers this configuration to the mIAB-DU via F1AP. The physical layer configuration may include, e.g., timeslot configuration (e.g., DUF), RB set configurations, HSNA configurations, SSB transmission configurations (e.g., STC) etc.

Regarding the update of the physical layer configurations of the mIAB-DU that needs to occur due to the mIAB-MT handover, there are several additional alternatives:
a. the second CU can learn the current mIAB-DU resource configuration from the first CU and issue the new configuration for the mIAB-DU to the anchor CU (e.g., via new Xn or via NGAP signalling). The anchor CU then reconfigures the mIAB-DU.
b. Otherwise, the second CU does not need to know the current configuration of the mIAB-DU, it can just issue the new configuration to the anchor CU, which reconfigures the mIAB-DU.
A measurement configuration or frequencies to be measured by the mIAB and relative reference signal configuration to perform the measurements on those frequencies (such as SMTC or SSB transmission configuration of other stationary or mobile IAB nodes).

Otherwise, the second CU may partially accept the request, or it can reject it. In case of partial acceptance, the second CU may send a “counteroffer” to the anchor CU, indicating, e.g., the QoS that it is able to provide to the BH RLC channels for which the requested capacity, QoS and/or control plane channel priority cannot be provided.

Regarding the update of the configurations of the mIAB-DU that need to occur due to the mIAB-MT handover, several options are possible:
the second CU can learn the current mIAB-DU resource configuration from the first CU and issue/send the new configuration for the mIAB-DU to the anchor CU (e.g., via new Xn or via NGAP signalling). The anchor CU then reconfigures the mIAB-DU.
Otherwise, the second CU does not need to know the current configuration of the mIAB-DU, it can just issue the new configuration to the anchor CU, which reconfigures the mIAB-DU.

Based on the configuration received from the anchor CU, the second CU configures the second D-DU and the new ancestors of the mIAB node with the backhaul resources and BAP routing entries for serving the mIAB node and establishes one or more BH RLC channels between the mIAB-MT and its parent node, and, if needed, between the ancestors of the mIAB node.

The examples in this step assume that, in the process of coordination between the anchor CU and second CU, the first CU is either not involved, or is acting as a relay. Alternatively, the first CU may, as a part of, or in parallel with the handover preparation for the mIAB-MT, send the above coordination information directly to the second CU, together with the identifier of the anchor CU (e.g., the gNB-ID and/or the IP address of the anchor CU), and inform the anchor CU that the handover of the mIAB-MT to the second CU is about to take place. The first CU may also send to the anchor CU an identifier of the second CU (e.g., the gNB-ID, target ID and/or the IP address of the second CU). After this, the second CU sends to the anchor CU:
The new IP address(es) to be used by the mIAB-DU (optional, otherwise the mIAB-DU can inform the anchor CU about the IP addresses/prefixes by itself).
The physical layer configuration for the cells served by the mIAB-DU, after which the anchor CU delivers this configuration to the mIAB-DU via F1AP. The physical layer configuration may include, e.g., timeslot configuration (e.g., DUF), RB set configurations, HSNA configurations, SSB transmission configurations (e.g., STC) etc.
A measurement configuration or frequencies to be measured by the mAB and relative reference signal configuration to perform the measurements on those frequencies (such as SMTC or SSB transmission configuration of other stationary or mobile IAB nodes).

As the mIAB moves within the area of the anchor CU, the identifier(s) of the cell(s) of the mIAB-DU will remain the same, since the mIAB will be connected to the anchor CU, and NR CGI(s) of the mIAB-DU cells need to reflect that. The cells served by the mIAB-DU are wandering cells with a stationary anchor point in the network.

In case of NGAP HO, either a direct forwarding tunnel is established between the anchor CU and the second CU, or, in case that direct forwarding is not available, indirect forwarding via the UPF is setup. In that case, all F1 traffic related to the mIAB-DU is mapped on that direct or indirect forwarding tunnel. The setup of the tunnel needs to consider the tunnel endpoint at the anchor CU and provide it to the second CU.

### Step 212: Subsequent mIAB-MT Handovers, without Changing the Anchoring CU of the mIAB-DU

The methods described above can be applied to arbitrarily many subsequent handovers of the mIAB-MT, where the CU currently serving the mIAB-MT (i.e., the source CU for the mIAB-MT handover) assumes the role of the first CU, and the CU (e.g. CU3 164) towards the which the mIAB-MT is handed over assumes the role of the second CU.

In this case, the source CU for the mIAB-MT handover coordinates with the anchor CU and the target CU of the mIAB-MT handover similar to the way described in the previous steps. At each mIAB-MT handover, the CU currently serving the mIAB-MT provides the identifier(s) of the target CU for the mIAB-MT handover to the anchor CU (e.g., the IP address(es), gNB-ID, target ID), and the identifier(s) of the anchor CU to the target CU, so that they can coordinate via NGAP, XnAP or via the CU currently serving the mIAB-MT that acts as a relay.

In a variant, the mIAB can be used as the “link” between the anchor CU and the CU currently serving the mIAB-MT. For example, the mIAB-MT receives the configuration parameters from the CU currently serving the mIAB-MT, the mIAB-MT passes the parameters to the co-located mIAB-DU, which then passes them to the anchor CU via F1AP (this may apply to both directions of the traffic).

### Step 214: mIAB-DU Performs IAB-DU Handover from Anchor CU to a New Anchor CU (Anchor CU2 172)

### Triggers for Executing the mIAB-DU Handover

The triggers may be configured to the mIAB by the OAM or by the anchor CU, and some non-limiting examples are as follows:
The mIAB-MT enters a cell that is in the new Tracking Area (TA), under a new donor. Herein, the mIAB-MT should report a TA of the serving cell and NR CGI to the mIAB-DU, so the mIAB-DU then checks the configuration with respect to when to initiate the migration.
Alternatively, the anchor CU may explicitly indicate to the mIAB-DU to start migration and provide the mIAB-DU with the necessary configurations, e.g., the IP address of the new anchor CU.
The anchor CU serves the mIAB-DU as long as the anchor CU has an XnAP connection with the CU currently serving the mIAB-MT or as long as the anchor CU can reach the CU currently serving the mIAB-MT indirectly, i.e., via one or two AMFs, by using NGAP signalling. Assume that the anchor CU has a XnAP connection to the third CU but not to the fourth CU. Just before the mIAB reaches the border between the third CU and the fourth CU, the mIAB-DU is handed over to the fourth CU. So, the anchor CU is maintained until the farthest CU to which the anchor CU has an XnAP connection or an (indirect) NGAP reachability via one or two AMF(s).
Properties of the Xn connectivity, if any, between the anchor CU and target CU, e.g. the latency estimated to transfer the user plane traffic associated to the mobile IAB node from the target CU to the anchor CU and vice versa.

### Migration of the mIAB-DU from the Source Anchor CU to the Target Anchor CU (Step 214)

When the network (e.g., the anchor CU) determines that the mIAB-DU handover needs to be executed, the current (i.e., source) anchor CU initiates the mIAB-DU handover procedure over XnAP or NGAP towards the new (i.e., target) anchor CU. The current anchor CU informs the new anchor CU about the traffic resources needed for serving the mIAB-DU traffic, where the coordination information may be as described in Steps 206 and 210:

The coordination information conveyed from the anchor CU to the second CU can be, e.g.:
An explicit or explicit indication of whether the mIAB-DU is or is not being handed over to the receiving CU;
The number of BH RLC channels needed to be established towards the mIAB;
The QoS and/or the priority of each of these BH RLC channels;
The capacity needed for each of these BH RLC channels;
(Optional) The number and type of IP addresses/IP address prefixes needed; and/or
The physical layer configuration for the cells served by the mIAB-DU. Then, either the new anchor CU delivers this configuration to the mIAB-DU or the new anchor CU delivers this configuration to the source anchor CU, which sends it to the mIAB-DU via F1AP. The physical layer configuration may include, e.g., timeslot configuration (e.g., DL/UL/flexible), RB set configurations, HSNA configurations, SSB transmission configurations (e.g., STC), etc.

The target anchor CU may fully or partially accept the request or reject it. In case of rejection or partial acceptance, further coordination may be needed.

### The Coordination between the Source/Target Anchor CU and the CU Currently Serving the mIAB-MT

The CU currently serving the mIAB-MT is involved in the coordination because it needs to provide (or continue providing) the backhaul support for the traffic to/from the mIAB-DU. Hence, as a part of the mIAB-DU handover procedure, or in parallel with or before it, the source (i.e., old) anchor CU indicates to the (i.e., new) anchor CU the identifier(s) of the CU currently serving the mIAB-MT (step 216), e.g., the gNB-ID, target ID, the IP address(es). It also provides the identifiers of the new anchor CU to the CU currently serving the mIAB-MT (step 218).

The new anchor CU then coordinates with the CU currently serving the mIAB-MT for setting up the backhaul between the CU currently serving the mIAB-MT and the mIAB-MT, as described in Steps 206 or 210 above.

Alternatively, the CU currently serving the mIAB-MT may forward the current backhaul configuration to the target anchor CU directly, after which the new anchor CU coordinates with the with the source anchor CU.

### Informing the CU Currently Serving the mIAB-MT about the mIAB-DU Handover (Step 220)

After the successful execution of the mIAB-DU HO procedure (or before the mIAB-DU HO execution, as a part of it, or in parallel with it):
The source (i.e., old)) anchor CU informs the CU currently serving the mIAB-MT that the mIAB-DU has been/is about to be handed over. This may result in the release of the configurations at the CU currently serving the mIAB-MT, for carrying the traffic to/from the mIAB-DU.
The old (i.e., former) anchor CU indicates to the CU currently serving the mIAB-MT the identifier(s) of the new anchor CU, e.g., the gNB-ID, target ID, the IP address(es), so that the CU currently serving the mIAB-MT can further coordinate with the new anchor CU.

An issue has been observed. During the mIAB-DU HO transition period, the mIAB-MT needs to deliver data for both F1 connections during a certain period, and it needs to be able to know whether an UL packet is to anchor CU1 or anchor CU2. This is because not all served UE keys will be updated at the same time. During this period with 2 F1 connections, the mIAB-MT can have 2 sets of IPs, one for each CU.

NOTE: the description of some embodiments assumes that the communication between CUs takes place via Xn. Alternatively, if there is no XnAP connection established between the CUS, the CUS may communicate indirectly, via the core network. For example, the anchor CU may send an NGAP message to the AMF, which can then forward the entire or parts of the message to the recipient CU. In an example, where the sender and receiver CUs are controlled by different AMFs, the message is also transmitted between the two AMFs. As mentioned earlier, in some examples, the CU currently serving the mIAB-MT may act as a relay, forwarding messages between the anchor CU and another CU.

### Executing mIAB-DU Handover at an Arbitrary Time

The previous examples assume that the mIAB-DU HO is executed at approximately the same time or in parallel with the mIAB-MT handover (whereas the mIAB-MT handover may also be executed without being accompanied by the mIAB-DU handover).

In some embodiments, the mIAB-DU handover can be executed at an arbitrary time, where the mIAB-MT is connected to the same CU both before and after the handover of the mIAB-DU. In this case, the mIAB-DU HO can be triggered in multiple ways.

In one example, the mIAB-DU HO is triggered by the anchor CU. The anchor CU may, e.g., based on the location and the trajectory of the mIAB node, conclude that the mIAB-DU should be handed over to another CU (e.g., fourth CU). The anchor CU may then send a message to the fourth CU, requesting the handover of the mIAB-DU, indicating the amount of resources needed for serving the mIAB-DU.

In a variant, the mIAB-DU HO is triggered by the CU serving the mIAB-MT, for example, based on a measurement report from the donor node.

In another variant, the mIAB-DU HO is triggered by the mIAB-MT, for example, based on a measurement report from the mIAB-MT.

In one variant, the mIAB-DU is handed over to an anchor CU that it is in charge of the area that the mIAB is just about to enter. In another variant, the mIAB-DU is handed over to an anchor CU that is even further in the direction of travelling, i.e., to an anchor CU that the mIAB-MT may or may not connect to further along the route.

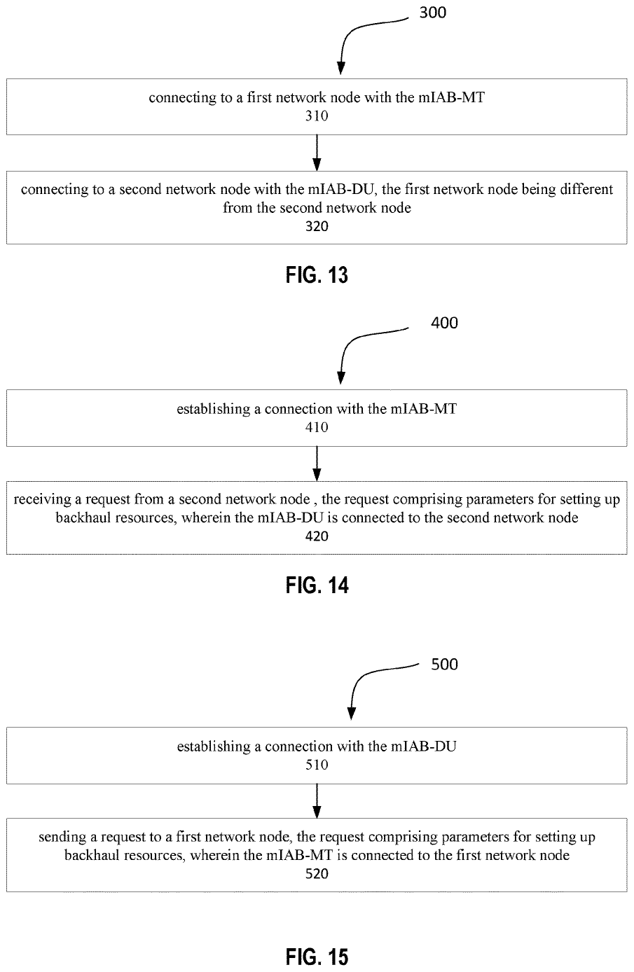

Based on the description given above and with reference to FIG. 12, FIG. 13 illustrates a flow chart of a method 300 for handling mobility of a mobile IAB node in an IAB network. The method can be performed in the mobile IAB node 150, which comprises a mIAB-MT 152 and a mIAB-DU 154. The method 300 comprises:
Step 310: connecting to a first network node with the mIAB-MT; and
Step 320: connecting to a second network node with the mIAB-DU, the first network node being different from the second network node.

In some examples, the connection between the first network node and the mIAB-MT can be a RRC connection. In some examples, the connection between the second network node and the mIAB-DU can be a F1 connection. In some examples, the mIAB-DU can be configured by OAM and/or via signaling from the first network node with parameters to connect to the second network node. In some examples, the mIAB-DU can be further configured by OAM and/or via signaling from the first network node with parameters to establish one or more of one or more TNL associations and one or more IPsec security associations, such as IPsec tunnels and IPsec transport modes. In some examples, the mIAB-MT node can send a measurement report to the first network node. In some examples, the mIAB node can receive a handover request for the mIAB-MT, based on the measurement report. In some examples, in response to the received request, the mIAB-MT can connect to a third network node, while the mIAB-DU stays connected with the second network node.

FIG. 14 illustrates a flow chart of a method 400 for handling mobility of a mobile IAB node in an IAB network, which will be described with reference to FIGS. 10 to 12. The method can be performed in a first network node, such as the source CU (CU1 160). The method 400 comprises:
Step 410: establishing a connection with a mIAB-MT;
Step 420: receiving a request from a second network node (e.g. anchor CU), the request comprising parameters for setting up backhaul resources, wherein the mIAB-DU is connected to the second network node.

In some examples, the second network node knows the contact details of the first network node, such as the gNB-ID of the first network node and the MT's UE XnAP ID at the first network node. In some examples, the parameters can comprise an indication of one or more of the following: a number of BH RLC channels needed to be established towards the mIAB-MT; a QoS and/or a priority of each of the BH RLC channels; a capacity needed for each of these BH RLC channels; a number and type of IP addresses or IP address prefixes needed; and a capability of the mIAB and/or the second network node. In some examples, the request can be a XnAP message or a NGAP message. In some examples, the first network node can accept the request and send an acknowledgement to the second network node. In some examples, the first network node may set up the backhaul resources towards the mIAB-MT. In some examples, the first network node may configure intermediate network nodes between the mIAB node and the first network node with backhaul resources. In some examples, the first network node may determine to handover the mIAB-MT to a third network node, in response to receiving measurement reports from the mIAB-MT, or based on other conditions. In some examples, the first network node may indicate to the second network node the handover of the mIAB-MT. In some examples, the first network node may indicate an identifier of the third network node to the second network node.

FIG. 15 illustrates a flow chart of a method 500 for handling mobility of a mobile IAB node in an IAB network, which will be described with reference to FIG. 12. The method can be performed in a network node, such as the anchor CU1 170 (referred to as a second network node below). The method 500 comprises:
Step 510: establishing a connection with the mIAB-DU; and
Step 520: sending a request to a first network node, the request comprising parameters for setting up backhaul resources, wherein the mIAB-MT is connected to the first network node.

In some examples, the connection between the mIAB-DU and the second network node can be a F1 connection. In some examples, the second network node may establish one or more of one or more TNL associations and one or more IPSec tunnels/security associations, prior to establishing the connection with the mIAB-DU. In some examples, the parameters comprise an indication of one or more of the following: a number of BH RLC channels needed to be established towards the mIAB-MT; a QoS and/or a priority of each of the BH RLC channels; a capacity needed for each of these BH RLC channels; a number and type of IP addresses or IP address prefixes needed; and a capability of the mIAB and/or the second network node. In some examples, the request can be a XnAP message or a NGAP message. In some examples, the second network node can configure the mIAB-DU with cell resources. In some examples, the second network node can receive an indication from the first network node of a handover of a mIAB-MT from the first network node to a third network node. In some examples, the second network node can receive an indication of an identifier of the third network node. In some examples, the second network node can determine whether the mIAB-DU should be migrated to the third network node or a target network node. In some examples, the second network node can determine whether the mIAB-DU should be migrated by determining if the F1 connection should be handed over to the target network node. In some examples, the second network node can exchange messages with the third network node for coordinating backhaul resources for the mIAB-MT. In some examples, the messages are XnAP messages. In some examples, the messages can be exchanged via NGAP signalling. In some examples, the second network node can determine that the mIAB-DU should be migrated to a fourth network node, e. g a new anchor CU. In some examples, the above determination can be based on one or more of a location, a trajectory of the mIAB node and availability of a Xn connectivity between the second network node and the fourth network node, etc. In some examples, the second network node can send an indication to the mIAB-DU to start a migration from the second network node to the fourth network node. In some examples, the second network node can send to the mIAB-DU an indication of an identifier of the fourth network node. In some examples, the second network node can send an indication of an IP address of the fourth network node. In some examples, the second network node can indicate to the mIAB-DU to change the F1 connection from the second network node to the fourth network node. In some examples, the second network node can send to the fourth network node an indication of an identifier of a network node serving the mIAB-MT.

Finally, a method in a communication system/network (e.g. IAB network) comprising a first network node (e.g. CU1), a second network node (anchor CU), a third network node (e.g. CU2) and a mIAB node including a mIAB-MT and a mIAB-DU is provided. The method comprises:
the mIAB-MT establishing a connection with the first network node;
the mIAB-DU establishing a connection with the second network node;
the second network node exchanging messages with the first network to set up backhaul resources for the mIAB node; and
the first network node determining that the mIAB-MT needs to be handed over to a third network node, wherein the mIAB-DU stays connected with the second network node.

In some examples, the mIAB-DU can migrate to a fourth network node (e. g anchor CU2. In some examples, the migration of the mIAB-DU can be triggered by the mIAB-MT entering a cell that is in a new TA and other triggers, which have been described above.

Other examples and details have been described above when describing the exemplary sequences of an implementation of a mobile IAB node migration.

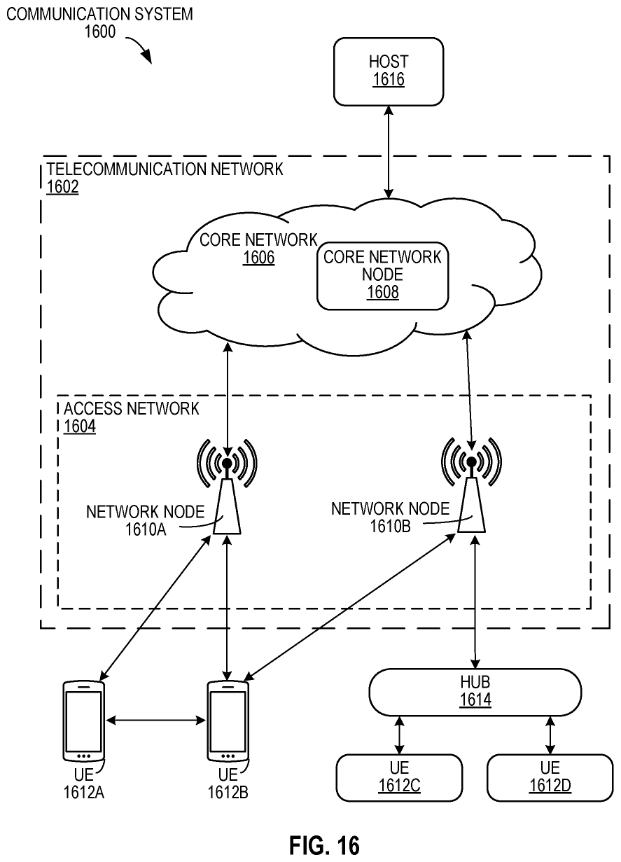

FIG. 16 shows an example of a communication system 1600 in accordance with some embodiments. In the example, the communication system 1600 includes a telecommunication network 1602 that includes an access network 1604, such as a RAN, and a core network 1606, which includes one or more core network nodes 1608. The access network 1604 includes one or more access network nodes, such as network nodes 1610a and 1610b (one or more of which may be generally referred to as network nodes 1610), or any other similar 3GPP access node or non-3GPP access point. The network nodes 1610 facilitate direct or indirect connection of UE, such as by connecting UEs 1612a, 1612b, 1612c, and 1612d (one or more of which may be generally referred to as UEs 1612) to the core network 1606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1600 may include any number of wired or wireless networks, network nodes, UEs, and/or any other components or systems that may facilitate or participate in the communication of data and/or signals whether via wired or wireless connections. The communication system 1600 may include and/or interface with any type of communication, telecommunication, data, cellular, radio network, and/or other similar type of system.

The UEs 1612 may be any of a wide variety of communication devices, including wireless devices arranged, configured, and/or operable to communicate wirelessly with the network nodes 1610 and other communication devices. Similarly, the network nodes 1610 are arranged, capable, configured, and/or operable to communicate directly or indirectly with the UEs 1612 and/or with other network nodes or equipment in the telecommunication network 1602 to enable and/or provide network access, such as wireless network access, and/or to perform other functions, such as administration in the telecommunication network 1602.

In the depicted example, the core network 1606 connects the network nodes 1610 to one or more hosts, such as host 1616. These connections may be direct or indirect via one or more intermediary networks or devices. In other examples, network nodes may be directly coupled to hosts. The core network 1606 includes one more core network nodes (e.g., core network node 1608) that are structured with hardware and software components. Features of these components may be substantially similar to those described with respect to the UEs, network nodes, and/or hosts, such that the descriptions thereof are generally applicable to the corresponding components of the core network node 1608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1616 may be under the ownership or control of a service provider other than an operator or provider of the access network 1604 and/or the telecommunication network 1602 and may be operated by the service provider or on behalf of the service provider. The host 1616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1600 of FIG. 16 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1602 is a cellular network that implements 3GPP standardized features. Accordingly, the telecommunications network 1602 may support network slicing to provide different logical networks to different devices that are connected to the telecommunication network 1602. For example, the telecommunications network 1602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1612 are configured to transmit and/or receive information without direct human interaction. For instance, a UE may be designed to transmit information to the access network 1604 on a predetermined schedule, when triggered by an internal or external event, or in response to requests from the access network 1604. Additionally, a UE may be configured for operating in single-or multi-RAT or multi-standard mode. For example, a UE may operate with any one or combination of Wi-Fi, NR and LTE, i.e. being configured for multi-radio dual connectivity (MR-DC), such as E-UTRAN (Evolved-UMTS Terrestrial Radio Access Network) NR-Dual Connectivity (EN-DC).

In the example, the hub 1614 communicates with the access network 1604 to facilitate indirect communication between one or more UEs (e.g., UE 1612c and/or 1612d) and network nodes (e.g., network node 1610b). In some examples, the hub 1614 may be a controller, router, content source and analytics, or any of the other communication devices described herein regarding UEs. For example, the hub 1614 may be a broadband router enabling access to the core network 1606 for the UEs. As another example, the hub 1614 may be a controller that sends commands or instructions to one or more actuators in the UEs. Commands or instructions may be received from the UEs, network nodes 1610, or by executable code, script, process, or other instructions in the hub 1614. As another example, the hub 1614 may be a data collector that acts as temporary storage for UE data and, in some embodiments, may perform analysis or other processing of the data. As another example, the hub 1614 may be a content source. For example, for a UE that is a VR headset, display, loudspeaker or other media delivery device, the hub 1614 may retrieve VR assets, video, audio, or other media or data related to sensory information via a network node, which the hub 1614 then provides to the UE either directly, after performing local processing, and/or after adding additional local content. In still another example, the hub 1614 acts as a proxy server or orchestrator for the UEs, in particular in if one or more of the UEs are low energy IoT devices.

The hub 1614 may have a constant/persistent or intermittent connection to the network node 1610b. The hub 1614 may also allow for a different communication scheme and/or schedule between the hub 1614 and UEs (e.g., UE 1612c and/or 1612d), and between the hub 1614 and the core network 1606. In other examples, the hub 1614 is connected to the core network 1606 and/or one or more UEs via a wired connection. Moreover, the hub 1614 may be configured to connect to an M2M service provider over the access network 1604 and/or to another UE over a direct connection. In some scenarios, UEs may establish a wireless connection with the network nodes 1610 while still connected via the hub 1614 via a wired or wireless connection. In some embodiments, the hub 1614 may be a dedicated hub-that is, a hub whose primary function is to route communications to/from the UEs from/to the network node 1610b. In other embodiments, the hub 1614 may be a non-dedicated hub-that is, a device which is capable of operating to route communications between the UEs and network node 1610b, but which is additionally capable of operating as a communication start and/or end point for certain data channels.

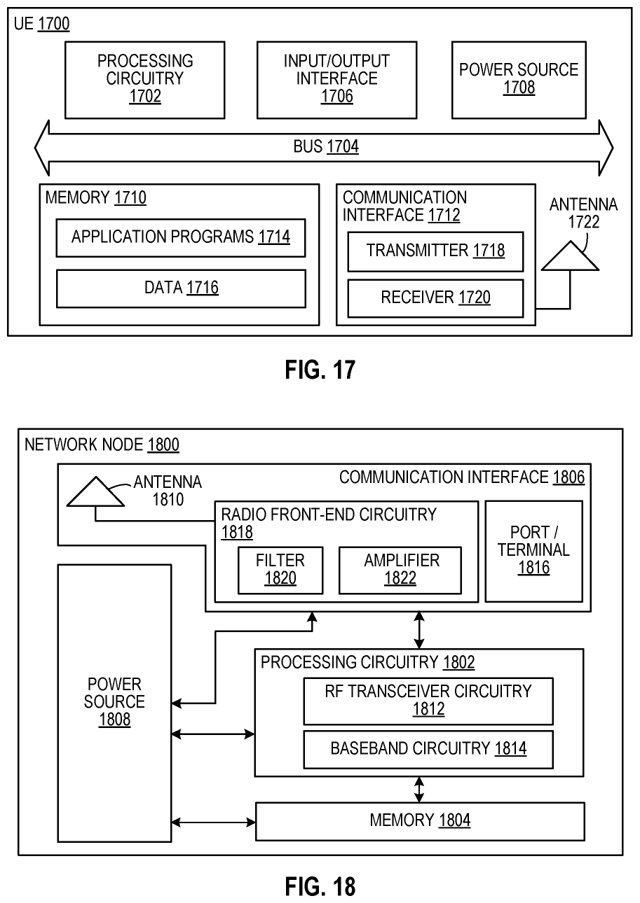

FIG. 17 shows a UE 1700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, vehicle-mounted or vehicle embedded/integrated wireless device, any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X).

The UE 1700 includes processing circuitry 1702 that is operatively coupled via a bus 1704 to an input/output interface 1706, a power source 1708, a memory 1710, a communication interface 1712, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

The processing circuitry 1702 is configured to process instructions and data and may be configured to implement any sequential state machine operative to execute instructions stored as machine-readable computer programs in the memory 1710. The processing circuitry 1702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1702 may include multiple central processing units (CPUs).

In the example, the input/output interface 1706 may be configured to provide an interface or interfaces to an input device, output device, or one or more input and/or output devices.

In some embodiments, the power source 1708 is structured as a battery or battery pack. Other types of power sources, such as an external power source (e.g., an electricity outlet), photovoltaic device, or power cell, may be used. The power source 1708 may further include power circuitry for delivering power from the power source 1708 itself, and/or an external power source, to the various parts of the UE 1700 via input circuitry or an interface such as an electrical power cable. Delivering power may be, for example, for charging of the power source 1708. Power circuitry may perform any formatting, converting, or other modification to the power from the power source 1708 to make the power suitable for the respective components of the UE 1700 to which power is supplied.

The memory 1710 may be or be configured to include memory such as random access memory (RAM), read-only memory (ROM), programmable ROM (PROM), erasable PROM (EPROM), electrically EPROM (EEPROM), magnetic disks, optical disks, hard disks, removable cartridges, flash drives, and so forth. In one example, the memory 1710 includes one or more application programs 1714, such as an operating system, web browser application, a widget, gadget engine, or other application, and corresponding data 1716. The memory 1710 may store, for use by the UE 1700, any of a variety of various operating systems or combinations of operating systems.

The memory 1710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1710 may allow the UE 1700 to access instructions, application programs and the like, stored on transitory or non-transitory memory media, to off-load data, or to upload data. An article of manufacture, such as one utilizing a communication system may be tangibly embodied as or in the memory 1710, which may be or comprise a device-readable storage medium.

The processing circuitry 1702 may be configured to communicate with an access network or other network using the communication interface 1712. The communication interface 1712 may comprise one or more communication subsystems and may include or be communicatively coupled to an antenna 1722. The communication interface 1712 may include one or more transceivers used to communicate, such as by communicating with one or more remote transceivers of another device capable of wireless communication (e.g., another UE or a network node in an access network). Each transceiver may include a transmitter 1718 and/or a receiver 1720 appropriate to provide network communications (e.g., optical, electrical, frequency allocations, and so forth). Moreover, the transmitter 1718 and receiver 1720 may be coupled to one or more antennas (e.g., antenna 1722) and may share circuit components, software or firmware, or alternatively be implemented separately.

In the illustrated embodiment, communication functions of the communication interface 1712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, NR, UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1712, via a wireless connection to a network node.

A UE, when in the form of an IoT device, may be a device for use in one or more application domains, these domains comprising, but not limited to, city wearable technology, extended industrial application and healthcare, etc. A UE in the form of an IoT device comprises circuitry and/or software in dependence of the intended application of the IoT device in addition to other components as described in relation to the UE 1700 shown in FIG. 17.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, e.g. a car, a ship, an airplane, or any equipment capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone.

FIG. 18 shows a network node 1800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs (NBs), evolved NBs (eNBs) and NR NBs (gNBs)), CUs (e.g. CUs 160, 162 and 164 of FIG. 12), donor DUs, mIAB nodes 150 (mIAB-MT 1521 and mIAB-DU 154), IAB nodes, anchor CUs (e.g. 170 and 172).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1800 includes a processing circuitry 1802, a memory 1804, a communication interface 1806, and a power source 1808. The network node 1800 may be composed of multiple physically separate components (e.g., a NB component and a RNC component, or a BTS component and a BSC component, etc.), which may each have their own respective components. In certain scenarios in which the network node 1800 comprises multiple separate components (e.g., BTS and BSC components), one or more of the separate components may be shared among several network nodes. For example, a single RNC may control multiple NBs. In such a scenario, each unique NB and RNC pair, may in some instances be considered a single separate network node. In some embodiments, the network node 1800 may be configured to support multiple radio access technologies (RATs). In such embodiments, some components may be duplicated (e.g., separate memory 1804 for different RATs) and some components may be reused (e.g., a same antenna 1810 may be shared by different RATs). The network node 1800 may also include multiple sets of the various illustrated components for different wireless technologies integrated into network node 1800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1800.

The processing circuitry 1802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1800 components, such as the memory 1804, to provide network node 1800 functionality. For example, the processing circuitry 1802 is configured to perform any actions/operations/blocks of methods 300, 400 and 500 of FIGS. 13, 14 and 15 respectively.

In some embodiments, the processing circuitry 1802 includes a system on a chip (SOC). In some embodiments, the processing circuitry 1802 includes one or more of radio frequency (RF) transceiver circuitry 1812 and baseband processing circuitry 1814. In some embodiments, the RF transceiver circuitry 1812 and the baseband processing circuitry 1814 may be on separate chips (or sets of chips), boards, or units, such as radio units and digital units. In alternative embodiments, part or all of RF transceiver circuitry 1812 and baseband processing circuitry 1814 may be on the same chip or set of chips, boards, or units.

The memory 1804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1802. The memory 1804 may store any suitable instructions, data, or information, including a computer program, software, an application including one or more of logic, rules, code, tables, and/or other instructions capable of being executed by the processing circuitry 1802 and utilized by the network node 1800. The memory 1804 may be used to store any calculations made by the processing circuitry 1802 and/or any data received via the communication interface 1806. In some embodiments, the processing circuitry 1802 and memory 1804 is integrated.

The communication interface 1806 is used in wired or wireless communication of signaling and/or data between a network node, access network, and/or UE. As illustrated, the communication interface 1806 comprises port(s)/terminal(s) 1816 to send and receive data, for example to and from a network over a wired connection. The communication interface 1806 also includes radio front-end circuitry 1818 that may be coupled to, or in certain embodiments a part of, the antenna 1810. Radio front-end circuitry 1818 comprises filters 1820 and amplifiers 1822. The radio front-end circuitry 1818 may be connected to an antenna 1810 and processing circuitry 1802. The radio front-end circuitry may be configured to condition signals communicated between antenna 1810 and processing circuitry 1802. The radio front-end circuitry 1818 may receive digital data that is to be sent out to other network nodes or UEs via a wireless connection. The radio front-end circuitry 1818 may convert the digital data into a radio signal having the appropriate channel and bandwidth parameters using a combination of filters 1820 and/or amplifiers 1822. The radio signal may then be transmitted via the antenna 1810. Similarly, when receiving data, the antenna 1810 may collect radio signals which are then converted into digital data by the radio front-end circuitry 1818. The digital data may be passed to the processing circuitry 1802. In other embodiments, the communication interface may comprise different components and/or different combinations of components.

In certain alternative embodiments, the network node 1800 does not include separate radio front-end circuitry 1818, instead, the processing circuitry 1802 includes radio front-end circuitry and is connected to the antenna 1810. Similarly, in some embodiments, all or some of the RF transceiver circuitry 1812 is part of the communication interface 1806. In still other embodiments, the communication interface 1806 includes one or more ports or terminals 1816, the radio front-end circuitry 1818, and the RF transceiver circuitry 1812, as part of a radio unit (not shown), and the communication interface 1806 communicates with the baseband processing circuitry 1814, which is part of a digital unit (not shown).

The antenna 1810 may include one or more antennas, or antenna arrays, configured to send and/or receive wireless signals. The antenna 1810 may be coupled to the radio front-end circuitry 1818 and may be any type of antenna capable of transmitting and receiving data and/or signals wirelessly. In certain embodiments, the antenna 1810 is separate from the network node 1800 and connectable to the network node 1800 through an interface or port.

The antenna 1810, communication interface 1806, and/or the processing circuitry 1802 may be configured to perform any receiving operations and/or certain obtaining operations described herein as being performed by the network node. Any information, data and/or signals may be received from a UE, another network node and/or any other network equipment. Similarly, the antenna 1810, the communication interface 1806, and/or the processing circuitry 1802 may be configured to perform any transmitting operations described herein as being performed by the network node. Any information, data and/or signals may be transmitted to a UE, another network node and/or any other network equipment.

The power source 1808 provides power to the various components of network node 1800 in a form suitable for the respective components (e.g., at a voltage and current level needed for each respective component). The power source 1808 may further comprise, or be coupled to, power management circuitry to supply the components of the network node 1800 with power for performing the functionality described herein. For example, the network node 1800 may be connectable to an external power source (e.g., the power grid, an electricity outlet) via an input circuitry or interface such as an electrical cable, whereby the external power source supplies power to power circuitry of the power source 1808. As a further example, the power source 1808 may comprise a source of power in the form of a battery or battery pack which is connected to, or integrated in, power circuitry. The battery may provide backup power should the external power source fail.

Embodiments of the network node 1800 may include additional components beyond those shown in FIG. 18 for providing certain aspects of the network node's functionality, including any of the functionality described herein and/or any functionality necessary to support the subject matter described herein. For example, the network node 1800 may include user interface equipment to allow input of information into the network node 1800 and to allow output of information from the network node 1800. This may allow a user to perform diagnostic, maintenance, repair, and other administrative functions for the network node 1800.

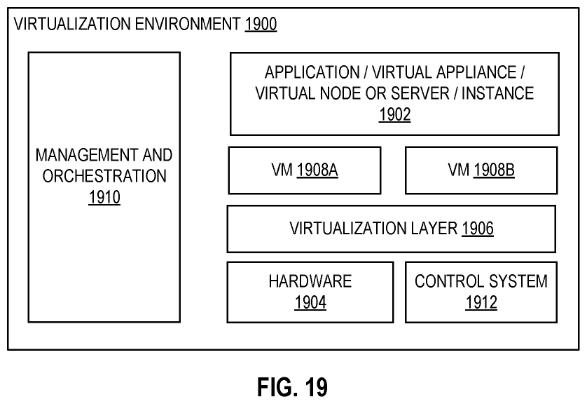

FIG. 19 is a block diagram illustrating a virtualization environment 1900 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1902 (which may alternatively be called software instances, virtual appliances, network functions, virtual nodes, virtual network functions, etc.) are run in the virtualization environment 1900 to implement some of the features, functions, and/or benefits of some of the embodiments disclosed herein.

Hardware 1904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1906 (also referred to as hypervisors or virtual machine monitors (VMMs)), provide VMs 1908a and 1908b (one or more of which may be generally referred to as VMs 1908), and/or perform any of the functions, features and/or benefits described in relation with some embodiments described herein. The virtualization layer 1906 may present a virtual operating platform that appears like networking hardware to the VMs 1908.

The VMs 1908 comprise virtual processing, virtual memory, virtual networking or interface and virtual storage, and may be run by a corresponding virtualization layer 1906. Different embodiments of the instance of a virtual appliance 1902 may be implemented on one or more of VMs 1908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1908 may be a software implementation of a physical machine that runs programs as if they were executing on a physical, non-virtualized machine. Each of the VMs 1908, and that part of hardware 1904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1908 on top of the hardware 1904 and corresponds to the application 1902.

Hardware 1904 may be implemented in a standalone network node with generic or specific components. Hardware 1904 may implement some functions via virtualization. Alternatively, hardware 1904 may be part of a larger cluster of hardware (e.g. such as in a data center or CPE) where many hardware nodes work together and are managed via management and orchestration 1910, which, among others, oversees lifecycle management of applications 1902. In some embodiments, hardware 1904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1912 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. In an example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. The benefits provided by such functionality are not limited to the processing circuitry alone or to other components of the computing device, but are enjoyed by the computing device as a whole, and/or by end users and a wireless network generally.

The above-described embodiments are intended to be examples only. Alterations, modifications and variations may be effected to the particular embodiments by those of skill in the art without departing from the scope of the description.

1. A method performed by a mobile Integrated Access Backhaul (IAB) node, in a communication network which comprises at least a first network node, a second network node and a third network node, the mobile IAB comprising a mobile IAB (mIAB)-Mobile Termination (MT) and a mIAB-Distributed Unit (DU), the method comprising;
connecting to the first network node with the mIAB-MT;
connecting to the third network node with the mIAB-DU, the first network node being different from the third network node, wherein during a migration, the mIAB-MT is handed over to the second network node and the mIAB-DU stays connected to the third network node, wherein the first network node is a first central unit (CU), the second network node is a second CU and the third network node is a third CU.

2. The method of claim 1, wherein the connection between the first network node and the mIAB-MT is a RRC connection.

3. The method of claim 1, wherein the connection between the third network node and the mIAB-DU is a F1 connection.

4. The method of claim 1, wherein the mIAB-DU is configured by Operation Administration and Management (OAM) and/or via signaling from the first network node with parameters to connect to the third network node.

5. The method of claim 1, wherein the mIAB-DU is further configured by OAM and/or via signaling from the first network node with parameters to establish one or more of one or more Transport Network Layer (TNL) associations and one or more IPsec security associations.

6. The method of claim 1, further comprising sending a measurement report from the mIAB-MT to the first network node.

7. The method of claim 6, further comprising receiving, from the first network node, a handover command for the mIAB-MT, based on the measurement report.

8. The method of claim 7, wherein the migration is in response to the received handover command.

9-17. (canceled)

18. A method performed at a second network node in a communication network which comprises at least a mobile Integrated Access Backhaul (mIAB) node, a first network node and a third network node, the mIAB node including a mIAB-Mobile Termination (MT) and a mIAB-Distributed Unit (DU), the method comprising:
connecting with the mIAB-MT, which is handed over from the first network node;
determining that the mIAB-DU is to stay connected with the third network node; and
exchanging messages with the third network node for coordinating backhaul resources for the mIAB-MT, wherein the first network node is a first central unit (CU), the second network node is a second CU and the third network node is a third CU.

19-20. (canceled)

21. The method of claim 18, wherein coordinating backhaul resources for the mIAB-MT further comprises coordinating one or more of quality of service (QoS) requirements, backhaul (BH) radio link control (RLC) channel configurations, traffic configurations.

22-23. (canceled)

24. The method of claim 18, further comprising receiving an indication from the first network node of the handover of the mIAB-MT from the first network node to the second network node.

25-28. (canceled)

29. The method of claim 18, wherein the messages are XnAP messages and/or the messages are exchanged via NGAP signalling.

30. (canceled)

31. The method of claim 18, further comprising determining that the mIAB-DU should be migrated to a fourth network node.

32. The method of claim 31, wherein the determining is based on one or more of a location, a trajectory of the mIAB node and availability of a Xn connectivity between the third network node and the fourth network node.

33. The method of claim 31, further comprising sending an indication to the mIAB-DU to start a migration from the third network node to the fourth network node.

34. The method of claim 33, further comprising sending to the mIAB-DU an indication of an identifier of the fourth network node.

35. The method of claim 33, further comprising sending an indication of an IP address of the fourth network node.

36. The method of claim 31, further comprising indicating to the mIAB-DU to change the F1 connection from the third network node to the fourth network node.

37. The method of claim 31, further comprising sending to the fourth network node an indication of an identifier of a network node serving the mIAB-MT.

38. A network node, comprising a network interface and processing circuitry connected thereto, in a communication network which comprises at least a first network node, a second network node and a third network node, the network node comprising a mobile IAB (mIAB)-Mobile Termination (MT) and a mIAB-Distributed Unit (DU), the processing circuitry configured to:
connect to the first network node with the mIAB-MT;
connect to the third network node with the mIAB-DU, the first network node being different from the third network node, wherein during a migration, the mIAB-MT is handed over to the second network node and the mIAB-DU stays connected to the third network node, wherein the first network node is a first central unit (CU), the second network node is a second CU and the third network node is a third CU.

39-42. (canceled)

43. (canceled)

44. (canceled)

45. (canceled)
